(19) United States
(12) Patent Application Publication
(10) Pub. No.: US 2020/0041887 A1
(43) Pub. Date: Feb. 6, 2020

(54) PROTECTION DISPLAY SYSTEM HAVING THREE-DIMENSIONAL CONVEX DISPLAY

(71) Applicant: Michael Foody, Saratoga, CA (US)

(72) Inventor: Michael Foody, Saratoga, CA (US)

(73) Assignee: Global Imagination, Inc., Campbell, CA (US)

(21) Appl. No.: 16/528,596

(22) Filed: Jul. 31, 2019

Related U.S. Application Data
(60) Provisional application No. 62/712,894, filed on Jul. 31, 2018.

(51) Int. Cl. G03B 21/20; G03B 21/56

(52) U.S. Cl. CPC G03B 21/208; G02B 26/008; G03B 21/56

(57) ABSTRACT

The present invention provides a projection display system having a three-dimensional convex display surface, such as a spherical or hemispherical display surface, in which the condenser lens before the optical modulating device may have a reduced focal distance for focusing the light more tightly on the optical modulating device, so as to illuminate only the center portion of the optical modulating device. Alternatively, the projection display system may have a square light pipe or any shaped light pipe in the optics in order concentrate the light to illuminate only a center portion of the optical modulating device or devices. The light pipe may be at least one of a round shape, pentagonal shape, a hexagonal shape, an octagonal shape, etc.

### FIELD OF THE INVENTION

This invention relates generally to a projection display system having a three-dimensional convex display surface and a projector for the same.

### BACKGROUND OF THE INVENTION

Currently, projection display systems having a spherical or hemispherical display surface have gained public recognition for displaying information, such as scientific, educational, virtual reality, entertainment, advertising, etc.

A conventional projector normally has a rectangular output display area, and thus has a rectangular optical modulating device (OMD) or rectangular optical modulating devices, such as one or three rectangular Digital Micromirror Device (DMD) or rectangular Liquid Crystal Display (LCD) panels, or a rectangular Liquid Crystal on Silicon (LCoS). During operation, a light beam produced by a light source and optics of the projector illuminates the entire rectangular optical modulating device(s), so as to generate a desired rectangular output image.

When a conventional projector is used to project an image onto a spherical display surface, as shown in FIG. 1, due to the geometry of the projector lens and the spherical display surface, only the image within a circle will be projected onto the spherical display surface. Thus, only the largest circle of light that fits within the rectangular display area or the rectangular optical modulating device makes it onto the spherical display surface, and the light outside the circle is wasted.

Therefore, in a projection display systems having a spherical or hemispherical display surface, it is beneficial to concentrate the light onto the center portion of the rectangular display area or the rectangular optical modulating device, i.e., the largest circle within the rectangular display area or the rectangular optical modulating device, so that all or substantially all of the available light reaches the sphere and is not wasted, thereby enhancing brightness of illumination thereof.

### SUMMARY OF THE INVENTION

The present invention provides a projection display system in which the light is concentrated onto the center portion of the display area, so that all or substantially all of the available light reaches the sphere and is not wasted.

The present invention provide a projection display system having a three-dimensional convex display surface, such as a spherical or hemispherical display surface, in which the condenser lens before the optical modulating device may have a reduced focal distance for focusing the light more tightly on the optical modulating device, so as to illuminate only the center portion of the optical modulating device. Additionally or alternatively, the projection display system may have a square light pipe so as to illuminate only a center square area of the optical modulating device. In alternative embodiments, the light pipe may have a section of a round shape, pentagonal shape, a hexagonal shape, an octagonal shape, etc., and lenses and light pipes may be used in combination.

The present invention also provide a method of retrofitting an existing projection display system having a three-dimensional convex display surface, such as a spherical or hemispherical display surface, comprising the steps of: replacing the condenser lens before the optical modulating device with condenser lens having a reduced focal distance; and/or replacing a rectangular light pipe of the existing projector with a square light pipe so as to illuminate only the center square of the optical modulating device, to focus the light more tightly on the optical modulating device, so as to illuminate only the center portion of the optical modulating device. In alternative embodiments, the rectangular light pipe may be replaced with a light pipe having a section of a round shape, pentagonal shape, a hexagonal shape, an octagonal shape, etc.

In all the embodiments of the present invention, the illuminated area covers at least the largest center circle that fitted within the optical modulating device, but does not cover the entire optical modulating device.

The present invention is illustrated or can be better understood through the accompanying drawings, and is defined in the accompanying claims.

### BRIEF DESCRIPTION OF DRAWINGS OF THE INVENTION

FIG. 1 is a schematic illustration, showing a prior art projection display system.

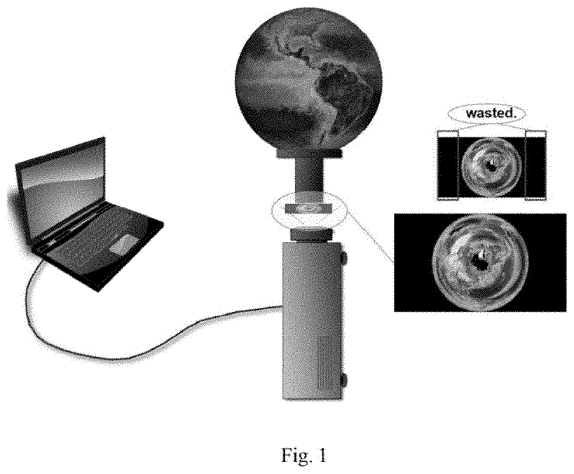

FIG. 2 is a schematic illustration, showing a projection display system of the present invention with a light pipe of square cross-section.

FIG. 3 is a schematic illustration, showing the optical mount of a projector with a replaced square light pipe of the present invention.

FIG. 4 is schematic illustration, showing a projection display system being implemented with an embodiment of the present invention.

FIG. 5 illustrates a projection display system of a preferred embodiment of the present invention without a light pipe.

FIG. 6 illustrates a traditional display from a projection lens onto a rectangular optical modulating device.

FIG. 7 illustrates a comparative display of the center illumination of the present invention on a rectangular optical modulating device.

### DETAILED DESCRIPTION OF THE INVENTION

The invention aims to provide an improved projection display system having a three-dimensional convex display surface, such as a spherical or hemispherical display surface, in which the light beam illuminates only the center of the optical modulating device, such as a Digital Mirror Device (DMD), or a Digital Light Processing (DLP) chip or a Liquid Crystal Display (LCD) or a Liquid Crystal on Silicon (LCoS) display, so all or substantially all of the available light reaches the spherical display surface, and is not wasted.

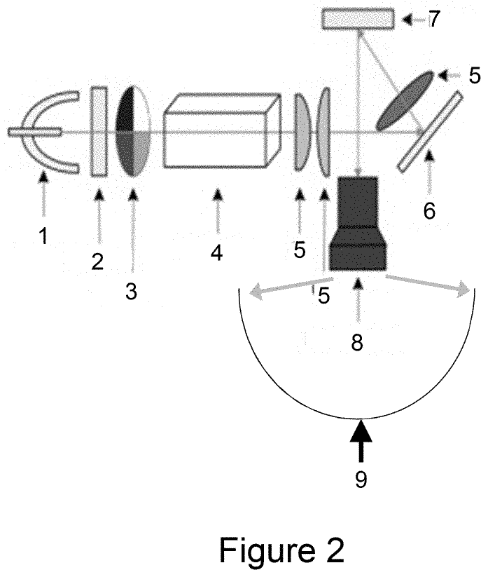

FIG. 2 is a schematic illustration of the full optical path of the invention, implemented in a lamp-based projection system, such as a Texas Instruments DLP chip as the OMD. A high-pressure arc (UHP) lamp 1 produces light that goes into a Ultra Violet (UV) light filter 2, and through a color wheel 3, after which, the light is transported via a light pipe 4 into an arrangement of condenser lenses 5 and a mirror 6. In a traditional projector design, the light pipe is rectangular and the light is directed onto the entirety of the DLP chip 7 as the OMD, and then through the projection lens 8 onto a hemispherical display surface 9 (or a spherical or other convex surface, not shown). In this embodiment of the invention, a square light pipe is used (replacing the rectangular light pipe), which results in only the center square area of the rectangular DLP chip being illuminated, but with the same amount of total light.

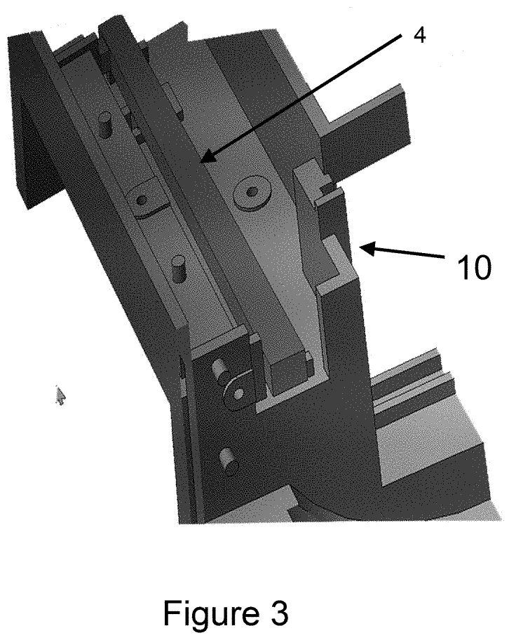

FIG. 3 is a detail solid model drawing of a projector, such as BenQ LK970 DLP projector's optical mount structure 10, with its factory-standard equipped rectangular light pipe having been replaced by a square light pipe 4, resulting in increased efficiency when used in conjunction with a spherical or hemispherical or convex display surface. The amount of light on the convex 3D display surface was increased by over 30% by only replacing the light pipe. When fully optimized, efficiency gains in 4K resolution projection engines can top 70%, with a theoretical maximum of approximately 76.85%.

Although not optimal, in some instances, from a cost perspective, it's simpler to illuminate only the center square of the OMD, not the entire optical modulating device—so most of the available light reaches the spherical display surface, and is not wasted. However, the present invention is not limited to illuminating a center circle or a center square of the optical modulating device, and it should also be within the scope of the invention to illuminate a center pentagon, a center hexagon, a center octagon etc. of the optical modulating device, if so desired. The pixels of the OMD are projected to the three-dimensional display surface.

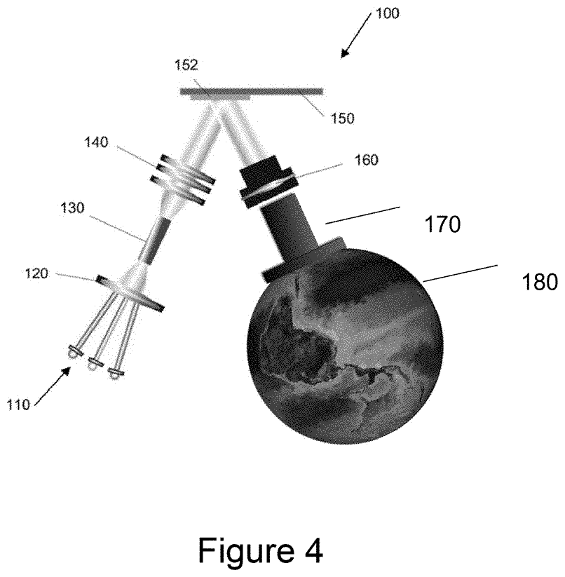

FIG. 4 shows a projection display system 100 according to another embodiment of the present invention, comprising a light source 110, condenser lens 120, a light pipe 130, optics 140, a DLP board 150 including a DMD 152 and projection optics 160, as well as a variable focal length fisheye lens 170 and a spherical display surface 180. In the embodiment of FIG. 4, the light pipe 130 has a hexagonal section so as to illuminate only the center hexagon of the DMD 152. The condenser lens 120 is optimized to condense the light to the hexagonal profile light pipe 130. In alternative embodiments, the light pipe 130 may have a cross section of a round shape, pentagonal shape, a square shape, an octagonal shape, etc. The pixels of the OMD are projected to the spherical display surface 180.

In further alternative embodiments, there are various ways to modify the projector optics of the projection display systems so as to illuminate only the center portion of the optical modulating device according to the present invention. In some embodiments, as compared to the prior art projector, the condenser lens before the optical modulating device, such as the condenser lens 5 of FIG. 2 or condenser lens 120 of FIG. 4, may have a reduced focal distance to focus the light more tightly on the optical modulating device, so as to illuminate only the center portion of the optical modulating device. The reduced focal distance means that it is shorter than the focal distance that would normally be necessary to illuminate the entirety of the rectangular optical modulating device. Those skilled in the art will understand that term “condenser lens” includes lens combinations that provide the condenser lens function.

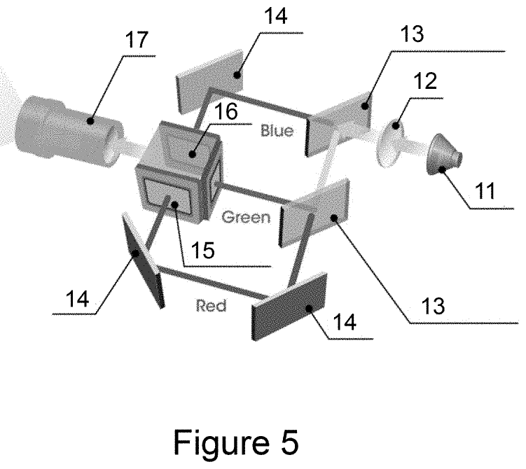

FIG. 5 shows a projection display system according to a further preferred embodiment of the present invention. As shown in FIG. 5, the projection display system 10 does not include a light pipe. In this embodiment, the light from lamp 11 is collected by the condenser lens 12 and is focused down to a smaller size than the full rectangular LCD panel 15. As shown, the light passes from the lens 12 to dichroic mirrors 13, and mirrors 14, until it reaches three LCD panels 15, and is recombined using a prism 16 before traveling through the projection lens 17 thereby the pixels of the OMD being projected to a three-dimensional convex display surface (not shown).

Although this embodiment of FIG. 5 which only has a condenser lens 12 is an LCD-based display, it is understood by those skilled in the art that DMD, LCD and LCoS-based projection systems may have optics with only a condenser lens, light pipe, relay lenses or may have various combinations.

Although in the aforesaid preferred embodiments, the projection display systems of the present invention may have a spherical display surface, the present invention is not limited thereto and can have a hemispherical display surface or a three-dimensional convex display surface.

The present invention also provide a method of retrofitting an existing projection display system comprising the steps of: replacing a rectangular light pipe of the existing projector with a square light pipe so as to illuminate only the center square of the optical modulating device; and/or replacing the condenser lens before the optical modulating device with a condenser lens having a reduced focal distance, so as to focus the light more tightly on the optical modulating device, so as to illuminate only the center portion of the optical modulating device. In alternative embodiments, the rectangular light pipe may be replaced with a light pipe having a cross section of a round shape, pentagonal shape, a hexagonal shape, an octagonal shape, etc.

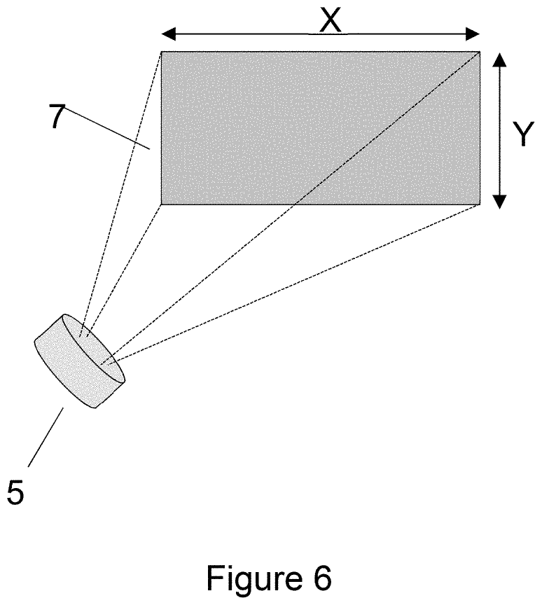

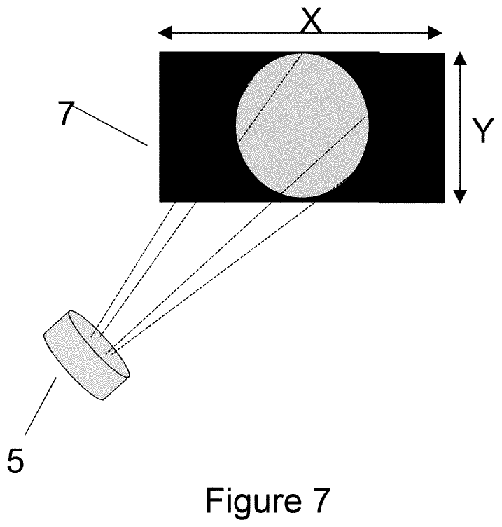

FIGS. 6 and 7 illustrate, respectively, the proportions of illumination according to a preferred embodiment as shown in FIG. 7 for comparation with a traditional projection display as shown in FIG. 6. For illustrative purposes, both use the same OMD 7. In the traditional system of FIG. 6, all the optics (illustrative of lens 5) prior to the OMD 7 serve to illuminate the entire rectangular OMD of width X and height Y. In the preferred embodiment of FIG. 7, the light is concentrated by the optics (illustrative of lens 5) prior to the OMD 7 so that the center illuminated portion is in the shape of a circle whose diameter matches the height Y of the rectangular display of OMD 7. Those skilled in the art will understand that the diameter matches the smaller of the width and height, if the OMD is not in a horizontal configuration.

Therefore, the improvement in efficiency is an approximation of the ratio of the width over the height of a rectangular OMD. In the case of a 4K resolution display (3840×2160), the efficiency improvement is 3840/2160, or 1.7685 (assuming a square light profile on the OMD). That ratio is also the inverse of the focal distance change for a condenser-lens.

The invention is thus described in connection with exemplary embodiments for illustrating the principle of the present invention, and not for limiting. It is obvious to those skilled in the art that the present invention may have various variations or modifications without departing from the spirit and essence of the present invention, and all such variations or modifications as would be obvious to those skilled in the art are intended to be within the scope of the present invention.

What is claimed is:

1. A projection display system, comprising:
a three-dimensional display surface having a convex shape; and
a projection system for projecting an image onto the entirety of the display surface, wherein the projection system includes at least a light source, n optics, and a rectangular optical modulating device;
wherein the light from the light source is concentrated through the optics onto a subset of the optical modulating device, and illuminates only a central portion of the optical modulating device.

2. The display system of claim 1, wherein the three-dimensional display surface is at least a portion of a sphere.

3. The display system of claim 1, wherein the projection system has one or more optical modulating devices.

4. The display system of claim 3, wherein the light is concentrated through a light pipe of a square cross section used in the optics into the shape of a square on the optical modulating devices.

5. The system of claim 3, wherein the light is concentrated to cover at least the smallest superset portion of the optical modulating devices whose pixels are projected onto the three-dimensional display surface.

6. The system of claim 3, wherein the light is concentrated through a light pipe of a round cross section used in the optics into the shape of a circle on the optical modulating devices.

7. The system of claim 6 wherein the light is concentrated to cover at least the portion of the optical modulating devices whose pixels are projected onto the three-dimensional display surface

8. The system of claim 3 wherein the light is concentrated through a light pipe of a cross sectional shape with more than four sides onto the optical modulating devices.

9. The system of claim 8, wherein the light is concentrated to cover at least the portion of the optical modulating devices whose pixels are projected onto the three-dimensional display surface.

10. The system of claim 3, wherein the concentration is accomplished by using a light pipe that is different than the shape of the optical modulating devices.

11. The system of claim 10, wherein the light pipe is one of square shape, round shape and a flat-sided shape of more than four sides

12. The system of claim 3, wherein the concentration of the light is accomplished through the optics with a shorter focal distance than that necessary to cover the entire optical modulating devices of rectangular shape.

13. A method of retrofitting an existing projector by replacing a light pipe of rectangular shape in the existing projector with a light pipe of a cross section of one of the square shape, round shape, and any shape of more than four sides so as to illuminate only a portion of optical modulating device or devices of rectangular shape of the existing projector.

14. The method of claim 13, wherein said illuminated portion of the optical modulating device or devices is the center portion.

15. A method of retrofitting an existing projector by replacing a condenser lens of an optics of the existing projector before optical modulating device or devices of rectangular shape of the existing projector with a condenser lens of shorter focal distance than that necessary to illuminate the entirety of the rectangular optical modulating device or devices, thereby illuminating only a portion of the rectangular optical modulating devices or devices.

16. The method of claim 15, wherein said illuminated portion of the optical modulating device or devices is the center portion.
